(19) United States
(12) Patent Application Publication
(10) Pub. No.: US 2025/0272362 A1
(43) Pub. Date: Aug. 28, 2025

(54) PROTECTION-LEVEL BASED MECHANISM FOR SECURING ARTIFICIAL INTELLIGENCE MODELS

(71) Applicant: Microsoft Technology Licensing, LLC, Redmond, WA (US)

(72) Inventors: Isuru Chamara PATHIRANA, Seattle, WA (US); Marcin Maciej STANKIEWICZ, Redmond, WA (US); Kumar RAJEEV, Redmond, WA (US); Glenn F. EVANS, Kirkland, WA (US); Priya Rakesh PATEL, Seattle, WA (US)

(73) Assignee: Microsoft Technology Licensing, LLC, Redmond, WA (US)

(21) Appl. No.: 18/759,776

(22) Filed: Jun. 28, 2024

Related U.S. Application Data
(60) Provisional application No. 63/556,755, filed on Feb. 22, 2024.

(51) Int. Cl. G06F 21/10

(52) U.S. Cl. CPC G06F 21/107

(57) ABSTRACT

Examples of the present disclosure describe systems and methods for providing a protection level-based mechanism for securing an AI model. In examples, a request to distribute an AI model to a client device is received. A license specifying at least one protection level for one or more portions of the AI model is identified at a licensing server. The hardware and/or software capabilities of the client device are evaluated to determine whether the client device is configured to support the protection level specified by the license for the AI model. If the client device is configured to support the protection level, the AI model is retrieved from an AI model distribution server and provided to the client device.

### BACKGROUND

Artificial intelligence (AI) models have been developed and leveraged for several cloud-based computing environments. Recently, there has been an interest in developing and leveraging AI models for client devices. However, one of the challenges associated with distributing AI models to client devices is protecting the AI models from being copied or stolen after the AI models have been implemented on the client devices.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

Examples of the present disclosure describe systems and methods for providing a protection level-based mechanism for securing an AI model. In examples, a request to distribute an AI model to a client device is received. A license specifying at least one protection level for one or more portions of the AI model is identified at a licensing server. The hardware and/or software capabilities of the client device are evaluated to determine whether the client device is configured to support the protection level specified by the license for the AI model. If the client device is configured to support the protection level, the AI model is retrieved from an AI model distribution server and provided to the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIGS. 1A-1B depict an example system for implementing the distributed AI-model security architecture discussed herein.

FIG. 2A depicts another example system for implementing the distributed AI-model security architecture discussed herein.

FIG. 2B depicts another example system for implementing the distributed AI-model security architecture discussed herein.

FIG. 2C depicts another example system for implementing the distributed AI-model security architecture discussed herein.

FIG. 2D depicts another example system for implementing the distributed AI-model security architecture discussed herein.

FIG. 3 depicts an example communication diagram for implementing the distributed AI-model security architecture discussed herein.

FIG. 4 depicts an example protection level scheme specified by a license for an AI model.

FIG. 5 depicts another example method for distributing an AI model to a client device in accordance with a license for the AI model.

FIG. 6 depicts another example method for distributing an AI model to a client device in accordance with multiple licenses for the AI model.

FIG. 7 is a block diagram illustrating example physical components of a computing device with which aspects of the technology may be practiced.

### DETAILED DESCRIPTION

AI models are programs that apply algorithms to data to detect patterns in the data, make predictions or conclusions about the data, and/or to perform actions based on the predictions or conclusions. As briefly discussed above, there has recently been an interest in developing and leveraging AI models for client devices. However, implementing AI models that have traditionally been leveraged in cloud-based computing environments in client devices potentially poses challenges. One such challenge is protecting an AI model that has been implemented in a client device from being copied or stolen from the client device.

The present disclosure provides a solution to the above-described challenges of securing the distribution of the AI models to client devices. Embodiments of the present disclosure describe systems and methods for providing a protection level-based mechanism for securing an AI model. In examples, a request to distribute an AI model to a client device is received. A license specifying at least one protection level for one or more portions of the AI model is identified at a licensing server. The hardware and/or software capabilities of the client device are evaluated to determine whether the client device is configured to support the protection level for the AI model. If the client device is configured to support the protection level, the AI model is retrieved from an AI model distribution server and provided to the client device. If the client device is not configured to support the protection level, an action may be performed to configure the client to support the protection level, or a different AI model may be retrieved and provided to the client device.

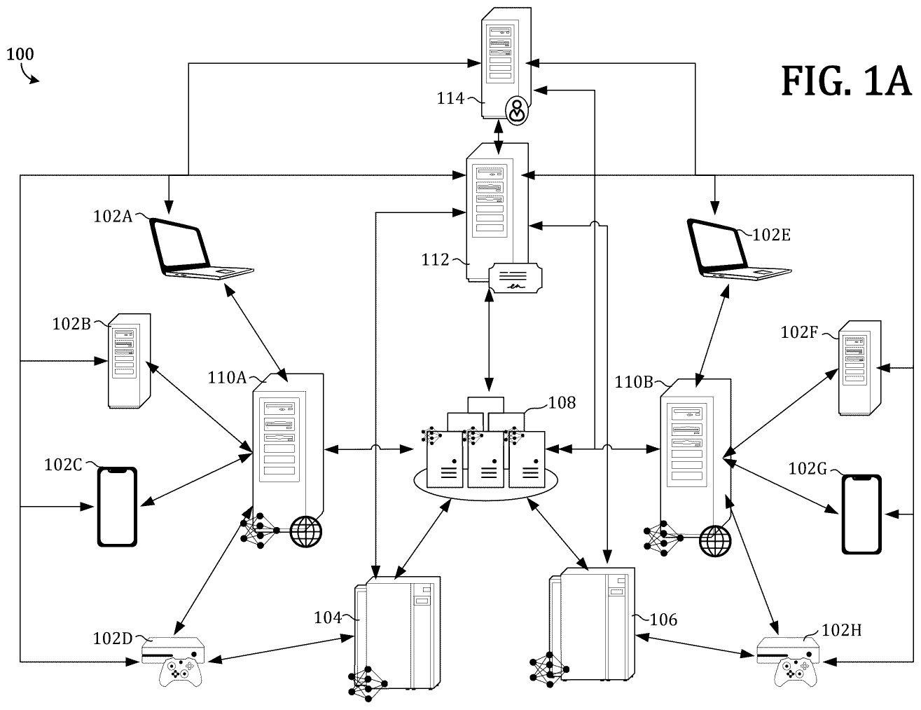

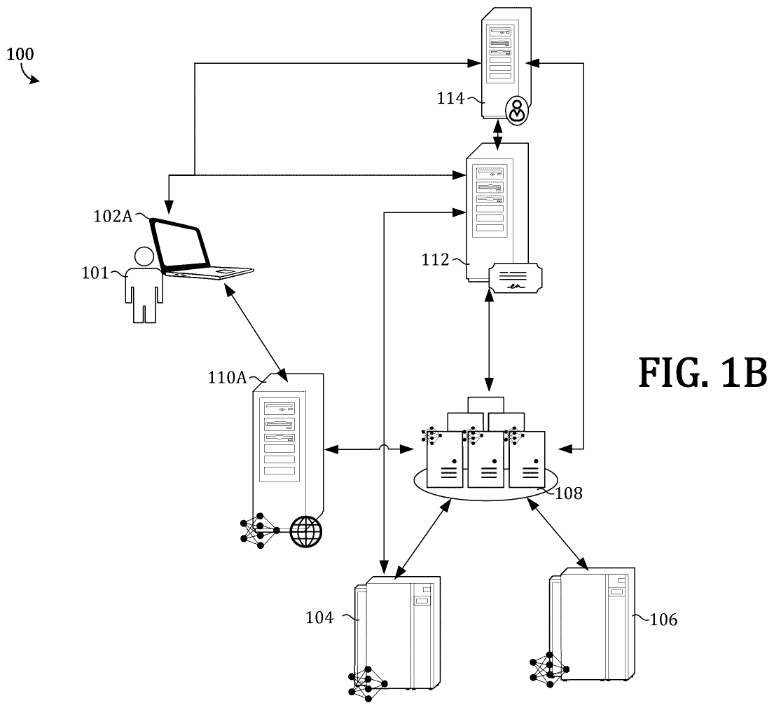

FIGS. 1A-1B depict an example system 100 for implementing the distributed AI-model security architecture discussed herein. System 100 is discussed first with reference to FIG. 1A and then a particular example of an AI model transfer is discussed with reference to FIG. 1B.

The system 100 includes a plurality of client devices 102, which are depicted as discrete client devices 102A-H. The client devices 102 ultimately receive and execute the models discussed herein. The client devices 102 may vary from many different types of devices, such as personal computers, laptops, tablets, smartphones, smart devices, gaming consoles, and even on-premises servers, among others.

The system 100 further includes a centralized server system 108 and a plurality of distributed servers 110, which are shown as a first distributed server 110A and a second distributed server 110B. The system 100 also includes a licensing server 112 and an account server 114. A model creation server 104, belonging to a model creator (e.g., entity that develops new AI models), and a training set server 106, belonging to a training set curator, may also be included in the system 100. The central server 108 may serve as a central point to distribute the models and/or training sets to the distributed servers 110. The distributed servers 110 may be distributed in varied geographical locations, such as different cities, states, regions, countries, etc. For instance, the first distributed server 112 may be located in Colorado and the second distributed server 110B may be located in Washington. The geographical differences in the distribution servers 110 allow for some of the distribution servers 110 to be closer to subsets of client devices than other distribution servers.

When a new AI model is created by a model creator, the AI model is initially stored in the model creation server 104. The model creator, which may be an entity (e.g., an individual user or a group of users) or a computing system (e.g., an automated model creation application, service, or system of one or more computing devices) then encrypts the AI model to form an encrypted model. The model creator, which may also be an entity or a computing system, also has access to the decryption key for decrypting the model. The decryption key may be the same as the encryption key in some examples. In other examples, the encryption key may be different from the decryption key. For instance, the encryption key may be a public key and the decryption key may be private key.

The encrypted model may also be compressed. Alternatively, the model may be compressed prior to being encrypted. The models tend to be very large in size (e.g., 1 GB or orders larger). As a result, reducing the storage and transmission size of the model is desirable. Accordingly, the model may be compressed on the model creation server 104 (and/or any other servers discussed herein that store the model). Examples of compression algorithms include Huffman coding algorithms, Shannon-Fano Coding algorithms, LZ77 algorithms, LZR algorithms, and Run Length Encoding algorithms. Other compression techniques used to compress the encrypted or unencrypted model include post training quantization (e.g., transforming model weights into lower precision representations) and pruning (e.g., removing model weights that contribute nominally to the model's overall performance).

The types of models that are created may be any type of ML/AI model, such as language models (LMs) and/or neural networks (NNs). For instance, large LMs (LLMs) and/or small LMs (SLMs) may be distributed and implemented with the technology discussed herein. Convolutional NNs (CNNs) and/or recurrent NNs (RNNs) may also be distributed and implemented. RNNs are often used for video and audio processing such as SuperResolution, camera noise reduction and processing, and/or audio microphone data enhancements (e.g. background noise removal such as music, dog barking, avatars). CNNs are often used for image processing and object detection.

The model itself may have multiple components that may be encrypted differently in some examples. For instance, the model may be considered include a network layer topology (e.g., the model code) and a model data (e.g., the model weights). These elements may be encrypted with different keys and decrypted with different keys. Accordingly, access to different parts of the model may be individually controlled. This allows for additional protections of the model while the model is being stored on the various servers discussed herein. In addition, different licenses, with differing security requirements, may be associated with the different model components. This allows for further refinement of control of the model usage and distribution. In addition, different portions of differently trained models (of the same type) may be combined. For instance, the model code of one model may be combined with the model weights of another model.

The model package may also be stored and transmitted in various different forms. Once example format is container, such as an Open Neural Network Exchange (ONNX) format. The ONNX model-container format allows for the model to be shared and implemented between different AI platforms and tools (e.g. DirectML, PyTorch, etc.). The ONNX data is comprised of assets (model data, weights) and the model structure (operators and functional ‘code’, topology). Each portion of the package may require different levels of protection due to the value of the component. The model package (e.g., ONNX container) may be encrypted and/or the components within the package or container may be encrypted.

The encrypted model is then transmitted from the model creation server 104. In one example, the model creation server 104 transmits the encrypted model to the centralized server system 108. The centralized server system 108 may then distribute copies of the encrypted model to the distributed servers 110. Accordingly, in the example depicted, the centralized server system 108 distributes the encrypted model to the first distributed server 110A and the second distributed server 110B.

In other examples, the model creation server 104 may transmit the encrypted model directly to the client devices 102. For instance, the client devices 102 may download or sideload the model more directly from the model creators. In some examples, the encrypted model may also be pre-installed on the client devices 102 prior to the client devices being sold. For instance, the model creation server 104 may work with the device manufacturers to include the encrypted model as part of the firmware and/or software of the client devices 102 as delivered to end users.

While only a single model and a single model creator have been discussed for simplicity, the system 100 handles many models of various different types from potentially many different model creators. The different models may be appropriate for different uses and/or for different types of devices. For example, the different models may be of different sizes that may be more appropriate for mobile use cases versus desktop use cases. The models may also have varying accuracy, with higher accuracy generally resulting in larger sizes. The different models may also have different security requirements (e.g., some models may need to be more secure than others). The models may also have different performance attributes (e.g., mobile use cases may need results faster. Other differences between the models are also possible.

In addition to transmitting the encrypted model, the model creator also generates the security requirements for the encrypted model. The security requirements for the encrypted model are transmitted to the licensing server 112, where the security requirements are stored as part of a license package for the particular model. The license package includes a license that functions as a container for storing, in addition to the security requirements, usage information for the particular model. In addition to providing the security requirements to the licensing server 112, the decryption key for the model is also provided to the licensing server 112.

The security requirements that are incorporated into the license include device-level requirements and/or software-level requirements. For instance, a model creator may require that particular hardware security features are available on the requesting client device 102. Some client devices 102 may have outdated or less capable hardware, whereas other client devices will have higher-end security hardware (e.g., secure memory protection hardware). Ensuring the security features are available on the particular client device 102 prior to decryption helps prevent against various different kinds of attack vectors, ranging from AI/ML-specific attacks to classical memory-scraping attacks. The security requirements may be based on particular hardware protections, central processing unit (CPU) protections, and/or output protections available on the client device 102. The security requirements may also have multiple tiers or levels that correspond to the resolution at which the model is allowed to operate, with higher capabilities corresponding to potentially higher resolutions.

More specifically, the security requirements and the license details can define who can use the model (e.g., user-level or account-level restrictions), what can use the model (e.g., device-level restrictions), how the model can be used (e.g., performance or usage restrictions), and/or when the model can be used (e.g., expiration periods, count limits).

The device-level restrictions may include restrictions on hardware or device identifiers and/or hardware manufacturers (e.g., Microsoft, Hewlett Packard, Dell). In some examples, a hardware root of trust (HROT) of the device is identified with a unique identifier by the manufacturer. These identifiers may be known by the model and/or training set creators and included within the license as a restriction, or effectively a permission list. For instance, a list of device or HROT identifiers may be included within the license as being approved to use the model (e.g., permit list). In other examples, a list of a list of device or HROT identifiers may be included within the license as being blocked to use the model (e.g., block list). In some examples, the permit or block lists may be based on device manufacturers. For instance, a model may be approved for use for all Microsoft or Dell devices.

In addition, the license may include restrictions on which organizations may use the model. For instance, the HROT may also include additional data (e.g., metadata) about organization to which the device belongs. As an example, once the client device is on premise of the organization, the organization may load organization-identifying metadata into the HROT. This organization-identifying information may then be used as a security restriction to approve devices belonging to a particular organization.

The license may also include security restrictions based on the specific hardware and/or software installed on the client device. For instance, the HROT may also include a listing of the hardware and/or software that is installed on the client device. For hardware devices, this may include neural processing units (NPUs), CPUs, graphics processing units (GPUs), and memory hardware, among other hardware used in client devices. The particular memory protections, CPU protections, and hardware protections that accelerators provide may also be included as security restrictions (and provided by the HROT) The security restrictions in the license may approve use of the model for only client devices including certain sets of hardware and/or minimum hardware requirements. In other examples, the security restrictions in the license may restrict usage of the model of devices with certain types of hardware. For example, a model creator may not allow a model to run on devices with a certain type of NPU and/or memory type.

The HROT may also include software capabilities of the particular client device, which may be used as security requirements in the license. For instance, certain devices may be provisioned with additional capabilities, such as the ability to process and/or decode certain types of data. As one example, some devices may have the capability to process device H.264 video streams, whereas others do not, which may be based on purchases and/or other software licenses of the client device. For instance, a device manufacturer may produce a device with hardware that is capable of processing many different codecs, but not all of them are enabled when the device is originally manufactured. When a license to a particular codec is acquired by the client device, a software switch can be enabled to activate the decoder capabilities for the particular codec. The data identifying such enabled capabilities may be stored and/or accessed by the HROT and used as security requirements within the license for the model. Similar to the other security requirements, these capabilities may be used to grant or deny a license for the model (e.g., permit list or block list of capabilities). For instance, the license can require a check as to a hardware/software capability before granting the license. Other hardware/software capabilities may include features such as decoding LLM models, a large amount of available memory, support of certain ML operators and/or extensions. By receiving this type of hardware and/or software data from the HROT, the data comes in a trusted, cryptographically hardened manner.

The license may also define performance limits that may restrict the inputs and/or outputs of the model as well as the resolution of the model. For instance, tokens per second output rate may be limited or defined within the license. The input context window size may also be limited or defined within the license. The performance limits may also be tied to the device-level data (e.g., hardware and/or software of the client device). For instance, a first set of client devices have a first hardware configuration and may be granted higher performance limits, and a second set of client devices have a second hardware configuration and may be granted lower performance limits. Despite the different performance limits, both the first set and the second set of client devices are allowed to use the model.

As another example, the amount of usage of the model may be specified. For instance, a usage count may be specified in the license. The usage count limits the number of times that a model is executed. The usage count may be tracked using, for example, digital rights management (DRM) software implemented by or accessible to the client device 102. The DRM software may store the usage count as an integer value or store objects representative of the usage count (e.g., model access tokens, user authentication tokens, or result set delivery tokens). The license may also specify a usage time. For instance, a time period may be specified for how long the model is valid for (e.g., an expiration time). The license may also specify a credit amount. For instance, the credit amount may be indicated as a monetary amount or as a data processing quantity (e.g., a number of accesses or uses). The usage restrictions may also include a limit on concurrent uses of the model. For instance, the license may specify a maximum number of actively running models on the client device.

The license may also include restrictions related to the models and/or training data sets that can be combined and/or used together. For instance, a license for a training set may specify a list of models for which the training set may be used. This may be in addition to the types of restrictions set forth above. A license for model may similarly restrict the types of training sets with which the model may be used or modified. As such, models and the training sets with which they are used may be separately licensed (and encrypted) and control of the combination is also provided.

Similarly, because the model code and the model weights may be separately encrypted and associated with different decryption keys, they may also be separately licensed. In such examples, the license requirements for both the model-code license and the model-weights license must be met before the combination of the two may be implemented. Thus, the local combining of different model code and model weights may be controlled via the licensing architecture discussed herein.

The license for the model may also restrict changes or generation of derivates of the models. For instance, license may prevent a client device from modifying the model in any way or generating a derivative model from the locally running model.

Once the licensing server 112 has received the security restrictions or requirements and the decryption key(s) for model, the licensing server 112 then creates a licensing package for the model. The licensing package includes at least: (1) a license that defines the security requirements provided by the model creator; and (2) the decryption key(s) for the model. In some examples, the license and/or the licensing package is encrypted. The licensing package may be associated with the model via a unique identifier (UID) for the particular model. For instance, the model may have a UID and the license package may be associated with the model via the same UID such that the licensing server 112 may identify the correct license package when a request for a license for a particular model is received. The licensing package is stored for later delivery and fulfillment of license requests.

The model creator and/or the operator of the centralized server system 108 may also have account-level and/or user-level requirements for use of the model. For instance, the security requirements defined in the license may be specific to software and/or hardware requirements of the client devices 102 (e.g., device-level security requirements). The model creator and/or the operator of the centralized server system 108 may also desire to restrict usage of the models to specific users and/or organizations. As an example, the model creator and/or the operator of the centralized server system 108 require a fee to paid to use the model and only those users or organizations with the fees paid are allowed to access the model.

These user-level requirements are transmitted to the account server 114 that manages authentication of the particular users of the client devices 102. For instance, when a request to the licensing server 112 is received, a request may also be received at the account server 114 to authenticate the user of the particular client device 102. If the account server 114 is able to authenticate the user, the account server 114 provides an authentication message to the licensing server 112 indicating the identity of the user and/or whether the user is authorized to have a license to the model.

When the licensing server 112 is able to: (1) verify the hardware and/or software requirements of the license based on data received from the requesting client device 102 and (2), in some examples, receive the authentication approval from the account server 114, the licensing server 112 transmits the licensing package for the model to the requesting client device 102. The client device 102 then also performs local security verifications and operations before extracting the decryption key from the license package, as discussed further herein.

Similar system operations may also be available for specialized training-set creators. For example, as discussed above, training set curation is also a particularly expensive process and security requirements are also required for developed training sets that may be used with the models discussed herein.

Similar to the models, the training-set creator generate an encrypted training set on the training set server 106. The encrypted training set is then transmitted, such as to the centralized server system 108 and/or more directly to the client devices 102 (e.g., sideloaded, downloaded, preloaded). In examples where the training set is transmitted to the centralized server system 108, the centralized server system 108 also transmits the encrypted training set to the distributed servers 110. The distributed servers 110 then provide the encrypted training set to the client devices 102 (e.g., upon request for the training set from the client devices 102).

The training-set creator then also defines the device-level security requirements for the training set with the licensing server 112. The decryption key for the training set is also transmitted from the training set server 106 to the licensing server 112. The licensing server 112 creates a licensing packaging with a license defining the security requirements for the training set and the decryption key for the training set. The training-set creator may also define the user-level security requirements with the account server 114.

Then, when a request for a license to the training set is received by the licensing server 112, the licensing server 112 processes the request similarly to the request for a license to a model as discussed above. For instance, once the licensing server 112 is able to verify the security requirements for the training set, the licensing package for the training set is delivered to the requesting client device 102. The client device 102 then performs additional security checks prior to extracting the decryption key from the licensing package.

For additional clarity, FIG. 1B depicts a subset of the system 100 shown in FIG. 1A. A particular example will now be discussed with respect to the components shown in FIG. 1B.

In an example, the first client device 102A is associated with a particular user 101. The user desires to utilize a specific model created by a model creator that operates model creation server 104. The user also desires to use the specific model with a specific training set curated by an operator of the training set server 106.

To identify the model and the training set, a request is first sent to the licensing server 112 from the first client device 102A. This request may be for the specific model and/or training set and/or for a list of available models and/or training sets. As an example, the request provides the hardware and/or software details of the first client device 102A (and potentially the identity of the user 101) to the licensing server 112. The licensing server 112 then provides a listing of the available models and/or training sets for which the user 101 and/or the first client device 102A are allowed to download based on the security requirements. In other examples, the request is merely a request for models and/or training sets without identifying information about the first client device 102A and/or the user 101. In such examples, the licensing server 112 provides a list of all the available models and/or training sets that are available to be delivered from the distributed servers 110 (e.g., models and/or training sets that have been received by the centralized server system 108).

When a selection of the particular model and/or training set is received, a best-suited distributed servers 110 is selected based on the first client device 102A. For instance, a distance between the first client device 102A and all the distributed servers 110 may be compared to identify one of the distributed servers 110 that is located most closely to the first client device 102A. The distance may be a physical distance and/or a network architecture distance. The distance may in some examples be based on different distance metrics, such as latency between the client devices and distributed servers, network transmission cost, etc. For instance, based on a routing map or pings between the first client device 102A and the distributed servers 110, a particular one of the distributed servers 110 is selected that is closest (e.g., shortest latency) to the distributed servers 110. In the example depicted, the closest of the distributed servers 110 is the first distribution server 110A.

A new request for the model and/or training set may then be generated from the first client device 102A and sent to the first distribution server 110A. For instance, the licensing server 112 may provide the Internet Protocol (IP) address or other identifier of the first distribution server 110A to the first client device 102A along with a UID for the model and/or training set. The first client device 102A generates a request with the UID and sends the request to the first distribution server 110A. In other examples, the licensing server 112 may send a request to the first distribution server 110A with the address of the first client device 102A and a UID of the model and/or training set to cause the first distribution server 110A to transmit the model and/or training set to the first client device 102A. In either example, the requested model and/or training set is delivered to the first client device 102A.

In some examples, the request for the model and/or training set also causes a request for the licensing package for the model and/or training to be generated from the first client device 102A and provided to the licensing server 112. In other examples, an interrogation of the model and/or training data set first occurs on the first client device 102A before a request for the licensing package is generated.

The request for the licensing package may include hardware and/or software information about the first client device 102A. This device data may be used for attestation and verification. For example, hardware/software certificates, and/or other evidence, may be delivered as part of the device data. The licensing server 112 then verifies that the device data meets the security requirements set forth in the corresponding license(s).

In the current example, user-level security requirements are also required for the model and/or training set. User-identity data is provided to the account server 114. The user identity data may include a username and password as well as other verification data in some examples (e.g., dual-factor authentication). The account server 114 receives and authenticates the user 101. The authentication verification is provided to the licensing server 112.

Upon verifying that the device data meets the security requirements and receives the authentication verification, the licensing server 112 provides the license package(s) for the model and/or training set to the first client device 102A. The first client device 102A then processes the license package to extract the decryption key and decrypt the model and/or training set, as discussed further herein.

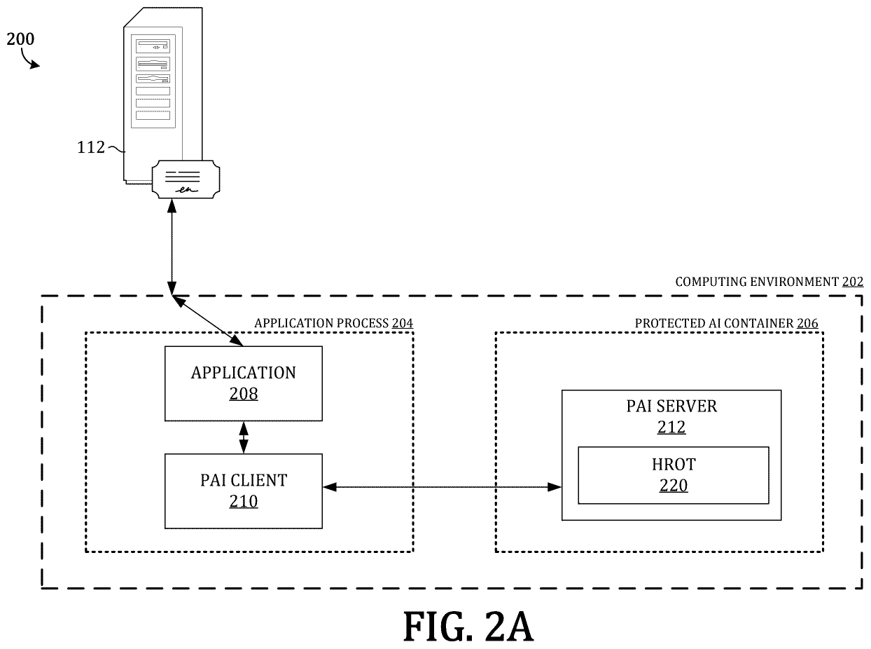

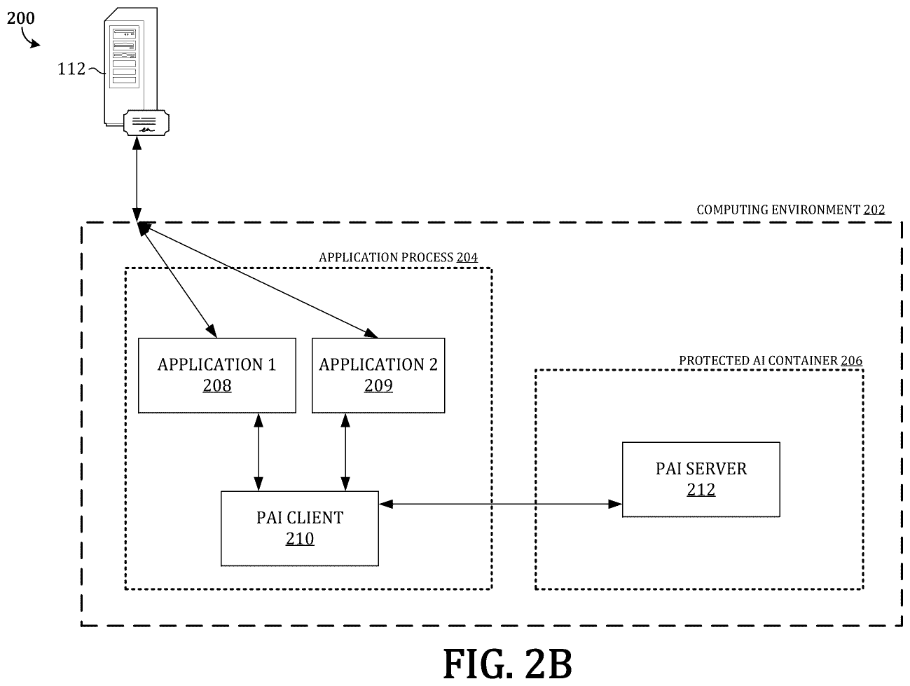

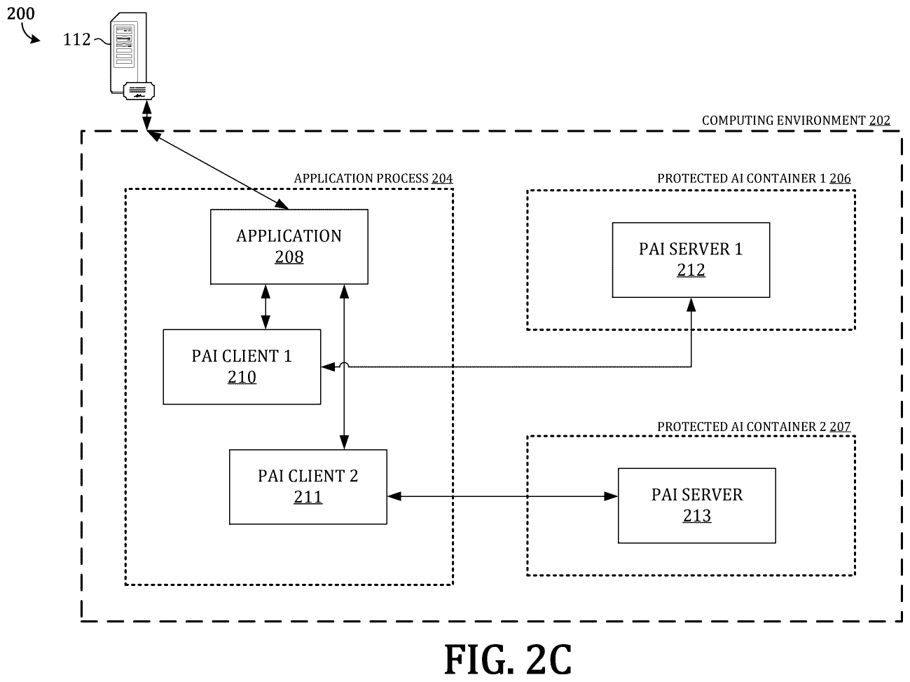

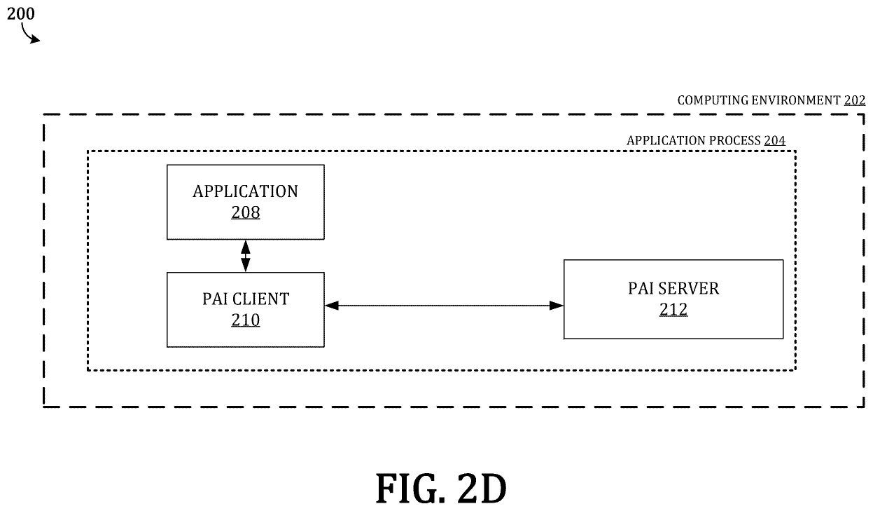

FIG. 2A depicts another example system 200 for implementing the distributed AI-model security architecture discussed herein. The system 200 includes the licensing server 112 and another computing environment 202. The computing environment 202, and/or a portion thereof, may be a client device 102. The computing environment 202 has received the model and/or training set. The computing environment includes an application process 204 and a protected AI (PAI) container 206. The application process 204 includes an application 208 and a PAI client 210. The application process 204 may also be considered a container in some examples. The PAI container 206 includes a PAI server 212.

The application process 204 and the PAI container 206 may operate on the same physical device. For instance, the PAI container 206 may be a separate, secure process from the application process 204. The PAI container 206 may also be implemented as an enclave (e.g., a secure network that is used to store and/or disseminate confidential data), a virtual machine (e.g., a compute resource that uses software instead of a physical computer to run programs, store data, and deploy applications), a hardware trust zone (e.g., a hardware-based security architecture that provides a secure software execution environment), an isolated execution environment (e.g., a secure software execution environment that enables the confidential execution of software), and/or an isolated security processor hardware (e.g., a dedicated hardware component that provides a secure software execution environment) on the same device as the application process 204. For instance, the PAI container may include or be a trusted execution environment (TEE). In other examples, the PAI container 206 may be implemented as a separate device from the application process 204.

The PAI server 212 performs the operations on the model and/or training set. For instance, the PAI server 212 performs the decryption operations, validation operations, and inference (e.g., input data processing) operations. In some instances, the PAI server 212 is implemented in C++, but other formats and languages are also possible.

The PAI client 210 may operate as an interface and/or library that hides the complexity of security solution of the PAI container 206 and PAI server 212 from the application 208. The application 208 interacts with the PAI container 206 using function calls, which may be simpler function calls than required to directly communicate with the model and/or PAI server 212. The PAI client 210 may then perform the operations to communicate with the PAI server 212 and retrieve the results generated from the model. In some examples, the PAI client 210 may be part of, or include, an application programming interface (API).

A hardware root of trust (HROT) 220 exists within the PAI server 212. The HROT 220 is trusted by the licensing server 112 and can provide security data to the licensing server 112 (via the PAI client 210 and the PAI server 212). The HROT 220 also is trusted to enforce of the security requirements of the license for the model. For instance, the HROT 220 has access to the corresponding hardware components, such as the memory, the NPU, GPU, and other types of hardware that may be used by the model. The HROT 220 may also configure the memory protections (e.g., encryption to dynamic random access memory (DRAM), protection of static random access memory (SRAM) memory access) for the device to comply with the security requirements.

Hardware-based security restrictions that are enforced by the HROT 220 provide for additional security for model usage. For instance, solely tying the model security to a user account is likely not a feasible solution because the user account is an abstraction controlled by the host operating system. The hardware itself cannot be as easily changed or manipulated.

The HROT 220 may be responsible for local enforcement of the security requirements in the license, and/or a subset thereof, such as the security restrictions and/or requirements discussed above. For instance, the HROT 220 is best positioned to ensure that the usage and performance restrictions set forth in the license are enforced (e.g., the model's tokens per second output rate, input context window size, hardware environment configuration, usage count, usage time, credit amount, or concurrency usage).

As some examples, the security requirements in the license that are enforced by the HROT 220 may include permissions for particular hardware features (e.g. a video or audio codec has been ‘purchased’/enabled on the machine). The amount of usage of the model can also be specified in the license and enforced by the HROT 220. For instance, a usage count may be specified in the license. The usage count limits the number of times that a model is executed. The HROT 220 monitors the number of times the model is executed and revokes functionality of the model once the count limit is reached. The license may also specify a usage time. For instance, a time period may be specified for how long the model is valid (e.g., an expiration time). The HROT implements a secure clock to monitor the time and revoke function of the model at expiration of the time period. The license may also specify a credit amount. For instance, the credit amount may include a data processing quantity. The HROT 220 monitors the processing resources consumed by the model operations (e.g., by monitoring the secure NPU/GPU processes) and revokes functionality of the model once the credit amount is reached.

The HROT 220 continues to monitor and enforce the security requirements of the license even after the initial verification. When the HROT 220 notices a condition that violates the security requirements of the license, the HROT 220 effectively locally revokes the local license by preventing functionality of the model from occurring. For instance, the HROT 220 can cause one or more hardware components to go into a blocked state with respect to data relating to the model. The prevention of the functionality may be related to the model directly or through control of the hardware to prevent the model from ultimately producing useful output. For instance, upon identifying a violation of the security requirements, the HROT 220 may remove decryption keys from the PAI client 210 so that the client can no longer decrypt data from the PAI server 212. Alternatively, instead of removing the decryption keys from the PAI client 210, the HROT 220 may cause the client to be blocked from using the decryption keys to decrypt data from PAI server 212. The HROT 220 can also block memory access, resulting in blank or null data when requests to such memory are issued.

Then, the next time communication is established between the PAI server 212 and the licensing server 112 (via the application 208 and PAI client 210), the PAI server 212 notifies the licensing server 112 that the security requirements are no longer met by the particular client. For instance, at different intervals, the licensing server 112 may be in communication with the PAI server 212 as check-in points to ensure continued compliance.

The application 208 may interact with the PAI server 212 via a web application programming interface (API). In some examples, the license may hold the decryption key for the model in a manner that is encrypted with the device certificate of the PAI server 212. The licensing server 112 may use its own certification to sign the license response that is provided to the application 208.

System 200 may also include a shared software development kit (SDK). The SDK includes the business logic, cryptographic operations, license generation, and validation data. The SDK may be used by both the PAI server 212 and the licensing server 112.

FIG. 2B depicts another example of system 200 for implementing the distributed AI-model security architecture discussed herein. The system 200 in FIG. 2B differs from the system 200 in FIG. 2A in that two applications are executing in the application process 204.

The application process 204 includes a first application 208 and a second application 209. After the model is securely installed in the PAI container 206, both the first application 208 and the second application 209 may interact with the model by sending commands to the PAI client 210. The PAI client 210 then communicates with the PAI server 212 on behalf of the applications 208-209. In this manner, the PAI server 212 and the model may remain secure while providing a single access point (e.g., the PAI client 210) for interaction with the secure model.

FIG. 2C depicts another example of system 200 for implementing the distributed AI-model security architecture discussed herein. The system 200 in FIG. 2C differs from the system 200 in FIG. 2A in that two models are in use in the computing environment 202.

In FIG. 2C, two different models have been installed in the computing environment 202. In some examples, the models could be implemented and operated by either the same PAI server and/or in the same PAI container. However, such implementation within the same secure environment may provide a possibility for an attack vector between the models themselves within the same environment. To avoid this potential attack vector or surface, the models are instead operated in two secure environments that are separated from one another. While more secure, the inclusion of additional servers or secure containers increases cost and overhead.

More specifically, in the example depicted, a first PAI container 206 includes a first PAI server 212. The first PAI server 212 operates a first model. The application 208 interacts with the first model via the first PAI client 210, which communicates with the first PAI server 212.

A second PAI container 207 includes a second PAI server 213. The second PAI server 213 operates a second model. The application 208 interacts with the second model via the second PAI client 211, which communicates with the second PAI server 213.

FIG. 2D another example of system 200 for implementing the distributed AI-model security architecture discussed herein. Unlike the example depicted in FIG. 2A, the example depicted in FIG. 2D is a lower-security, but less resource-intensive implementation. For instance, a license server is no longer implemented and a PAI container 206 is also no longer implemented.

In this example, rather than retrieving the decryption key for the model as part of a license package from a license server, the decryption key is received as part of the model package when the model package is downloaded or otherwise installed in the device. The model package may also define security requirements that are to be met before the decryption key can be used. In this situation, trust is put into the client device (e.g., computing environment 202) to perform the security verifications. In some examples, the client device is able to derive the decryption key from the model package based on a secret seed and key ID value. The seed may be randomly pre-generated and stored within the application 208, the PAI client 210, and/or the PAI server 212. The decryption key may also be generated based on values read from the model (so the seed cannot be read directly from the binary). The seed and key ID are then provided as input to a key derivation function that generates the content key.

In this example, the PAI server 212 also runs within the application process 204 rather than a separate, protected application process 204. In other examples, however, the PAI server 212 may run in a separate application process 204.

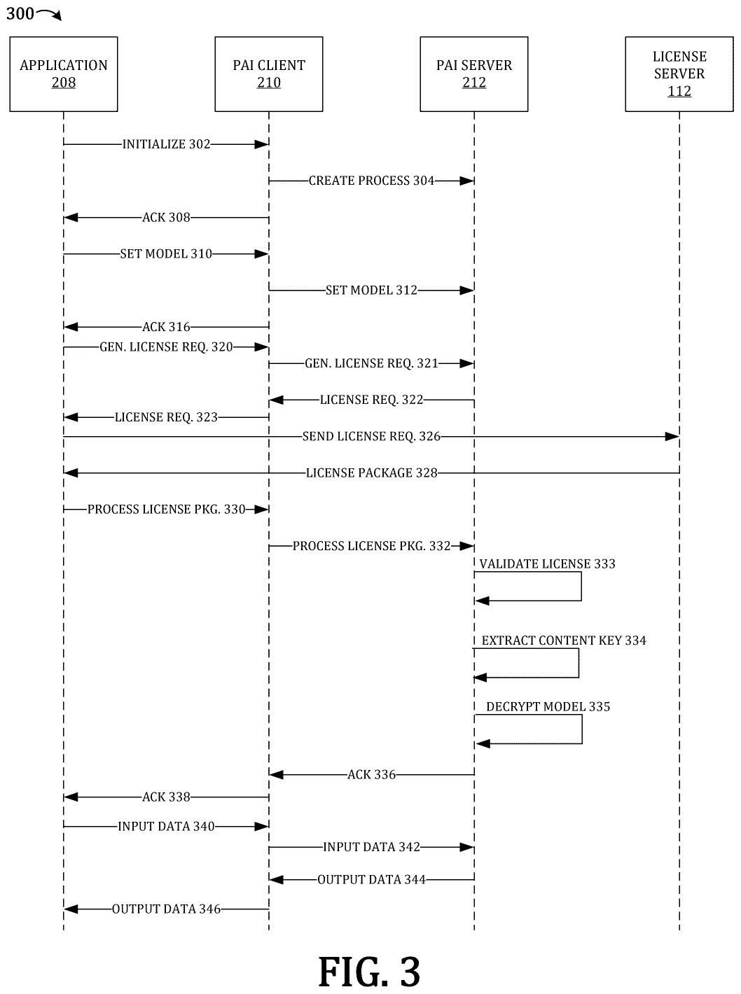

FIG. 3 depicts an example communication diagram 300 for implementing the distributed AI-model security architecture discussed herein. The communication diagram depicts communications between the application 208, the PAI client 210, the PAI server 212, and the licensing server 112, respectively.

An initialize message 302 is first sent from the application 208 to the PAI client 210. A create process message 304 is then sent from the PAI client 210 to the PAI server 212. The create process message 304 causes the creation of the PAI server 212 and/or the secure processes and containers associated with the PAI server 212. An acknowledgement message 308 may then be sent from the PAI client 210 to the application 208 indicating that the protected process has been created.

The application 208 then sends a set model message 310 to the PAI client 210 that may include the downloaded encrypted model package (e.g., an ONNX package including the model components). In other examples, the set model message 310 includes an indication of where the encrypted model is stored on the device (as the model has already been downloaded to the device). The PAI server 212 can then ultimately cause the model to be stored in the secure memory rather than unsecure memory when the model is initially downloaded. The set model message 312 is then provided to the PAI server 212 from the PAI client 210. The PAI server 212 then stores the encrypted model package in the secure memory to which the PAI server 212 has access. An acknowledgment message 316 may then be generated and provided to the application 208 to indicate that the encrypted model has been stored.

The application 208 then generates a request message 320 for a license request. This “request-for-a-request” message may be referred to herein as a GLR message 320. The GLR message 320 is then passed from the PAI client 210 to the PAI server 212 as GLR message 321. The PAI client 210 may also modify or augment the GLR message 321 for the PAI server 212.

In response to the GLR message 321, the PAI server 212 interrogates the stored model package to extract data about the model or from the model included in the license request. In some examples, the PAI server 212 also aggregates security data about the software and/or hardware of the computing environment 202, the application process 204, and/or the PAI process 206. For instance, the HROT 220 may examine the model to determine what the model requires and includes the attestation details that are likely needed by the license and/or by the licensing server 112 to approve the license request and deliver the license. As discussed above, the HROT 220 includes or has access to data or metadata about the hardware and/or software capabilities and/or configurations of the client device. These hardware and/or software capabilities and/or configurations of the client device are incorporated into the license request that is generated and passed from the PAI server 212. By generating this type of hardware and/or software data from the HROT 220, rather than from an untrusted application 208, the data is provided to the licensing server 112 in a trusted, cryptographically hardened manner. Thus, the licensing server 112 is able to make a higher-trust evaluation of the data when determining whether to grant the license for the model.

The license request that generated from the PAI server 212 may also be encrypted such that the PAI client 210 and/or the application 208 cannot read the license request itself. In some examples, the license request is partially encrypted and/or securely hashed to prevent tampering. The licensing server 112, however, includes a decryption key and can decrypt the license request upon receipt.

The license request message 322 including the data about the model (or extracted from the model) and the device-level security data (where available) is then transmitted from the PAI server 212 to the PAI client 210. The PAI client 210 then sends a license request message 323 (containing substantially the same information) to the application 208.

Once the application 208 has received the license request message 323, the application 208 generates and sends a license request message 326 to the licensing server 112. The license request message 326 includes at least a portion of the data included in the license request message 323. For instance, the license request message 326 includes an identifier for the model for which a license is requested. The license request message 326 may also include the device-level security data from the PAI server 212.

The license request message 326 is processed by the licensing server 112, as discussed further herein. If the licensing server 112 approves the license request, a license package 328 is transmitted from the licensing server 112 to the application 208.

The application 208 generates a process-license-package message 330 and transmits the message to the PAI client 210. The process-license-package message 330 includes the license package for the model. The PAI client 210 processes the process-license-package message 330 and transmits its own process-license-package message 332 to the PAI server 212.

When the PAI server 212 receives the process-license-package message 331, the PAI server 212 then performs operations to process the received license package. The example operations include a validate-license operation 333, an extract-content-key operation 334, and a decrypt-model operation 335.

The validate-license operation 333 includes locally validating the security requirements set forth in the license. The validate-license operation 333 operation may also first determine that the license package received is valid, such as by checking that the license package came from an approved license server and/or is associated with an approved device identifier (e.g., media access control (MAC) address).

Once the license requirements are validated, the extract-content-key operation 334 is performed to extract the decryption key from the license package. The extracted decryption key is then used to decrypt the encrypted model at the decrypt-model operation 335. The decrypted model is then stored within the secure memory to which the PAI server 212 has access. The decrypted model may then be used to locally process and analyze new input data. In examples where the model is in an ONNX model package, the model package is compiled/translated into DirectML to be executed by the GPU and/or NPU. An independent hardware vendor (IHV) driver may then translate the DirectML commands into microcode blocks which are submitted to the IHV kernel driver for execution.

Once the model is decrypted, installed, and ready for use, an acknowledgement message 336 is sent from the PAI server 212 to the PAI client 210 indicating that the model is ready. The acknowledgement is then passed to the application 208 as acknowledgement message 338. Based on the acknowledge message, the application 208 is aware that input data can now be provided as input for the model.

The application 208 then sends, to the PAI client 210, input data 340 for the model to process. The PAI client 210 may adjust or package the input data in some examples. For instance, in some cases the input data is translated into commands for the specific model, which may include translating into DirectML commands or similar command types. In other examples, the input data is not modified. The PAI client 210 then transmits the input data 342 to the PAI server 212. The model then processes the input data while executing in the secure PAI process 206.

The output data 344 that is generated from the model is transmitted from the PAI server 212 to the PAI client 210. The PAI client 210 may adjust and/or package the output data. In other examples, the PAI client 210 does not adjust or modify the output data. The output data 346 is then transmitted to the application process 204.

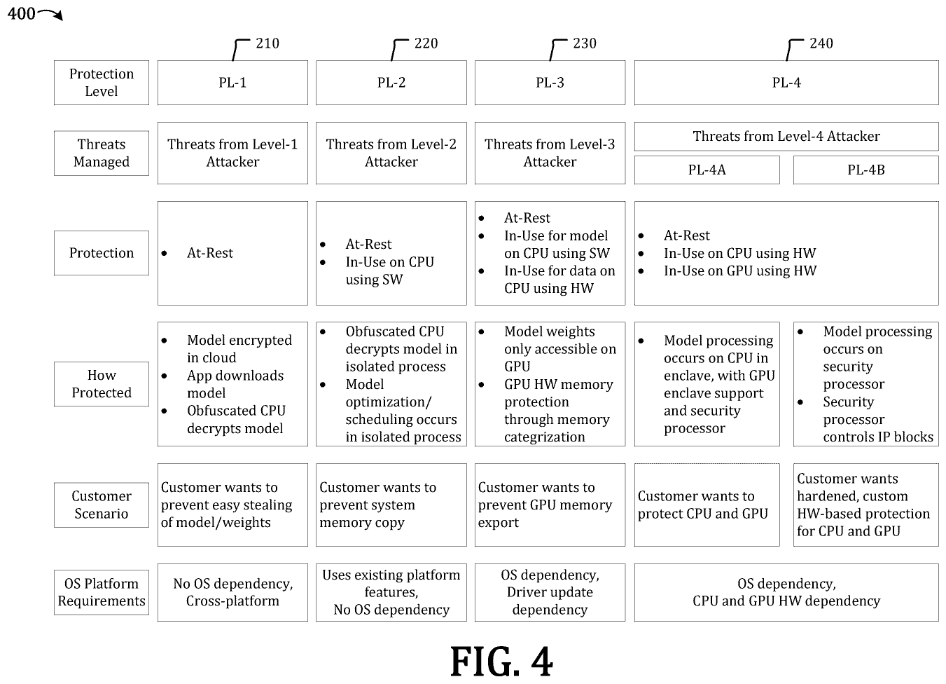

FIG. 4 depicts an example protection level scheme 400 specified by a license for an AI model. Protection level scheme 400 includes protection levels 1-4, the properties of which are included in columns 410, 420, 430, and 440, respectively. Although protection level scheme 400 is depicted as comprising four protection levels, protection level scheme 400 may include additional or fewer protection levels than those described in FIG. 4. Further, properties of the protection levels of protection level scheme 400 (e.g., threats managed, protection, how protected, customer scenario, operating system platform requirements) may be different from than those described in FIG. 4.

In FIG. 4, protection level 1 (PL-1) is described by the properties listed in column 410. Specifically, PL-1 is intended to manage against threats from a Level-1 attacker, such as a low-privilege user, while the AI model is at rest (e.g., is not actively being used by the client device). PL-1 protects the AI model by encrypting the AI model in the cloud, causing the application that intends to use the AI model to download the AI model, decrypting the AI model using an obfuscated CPU (e.g., the description or structure of the CPU is modified to intentionally conceal the functionality of the CPU), and causing the application to use the AI model for inferencing (e.g., executing the AI model against data to generate an output). PL-1 does not indicate an operating system dependency requirement for the AI model and permits cross-platform usage of the AI model. In examples, PL-1 is used when a user desires to increase the difficulty of acquiring unauthorized access to the AI model data (e.g., the AI model weights).

Protection level 2 (PL-2) is described by the properties listed in column 420. Specifically, PL-2 is intended to manage against threats from a Level-2 attacker, such as an administrator (e.g., of client devices 102), while the AI model is at rest or in use by (e.g., in the memory of) a CPU using software-based protections. PL-2 protects the AI model by using an obfuscated CPU to decrypt the AI model in an isolated, protected process or environment (e.g., PAI container 206) and performing optimization and scheduling of the AI model in the isolated, protected process or environment. PL-2 does not indicate an operating system dependency requirement for the AI model and permits usage of existing features of the client device's operating system. In examples, PL-2 is used when a user desires to prevent a system memory copy of a CPU of the client device (e.g., to prevent the AI model data or software code from being copied while the AI model is in use on the client device).

Protection level 3 (PL-3) is described by the properties listed in column 430. Specifically, PL-3 is intended to manage against threats from a Level-3 attacker, such as a user having physical access and software/firmware access to the client device. PL-3 provides protection for an AI model while the AI model is at rest or in use by a CPU using software-based protections, protection for the AI model data while the AI model is in use by a CPU using hardware-based protections, and protection for the AI model and model data while the AI model is in use by a GPU using hardware-based protections. In addition to the protections provided by PL-2, PL-3 protects the AI model by restricting access to the AI model data (e.g., model weights) to the GPU executing the AI model and providing hardware memory protection for the GPU via memory categorization (e.g., specifying operations that can be performed for specific memory address ranges of the GPU). PL-3 indicates an operating system dependency requirement and a driver update dependency requirement for the AI model. In examples, PL-3 is used when a user desires to prevent the export of memory from the GPU.

Protection level 4 (PL-4) comprises protection levels PL-4A and PL-4B and is described by the properties listed in column 440. Specifically, PL-4 is intended to manage against threats from a Level-4 attacker, such as a user having physical access to the client device and access to advanced hardware or software attacking tools. PL-4 provides protection for an AI model while the AI model is at rest, in use by a CPU using hardware-based protections, or in use by a GPU using hardware-based protections. In addition to the protections provided by PL-3, PL-4A protects the AI model by performing processing of the AI model on a CPU in a hardware-protected enclave (e.g., a CPU execution mode that provides an isolated, hardware-protected execution space), whereas PL-4B protects the AI model by performing processing of the AI model on a security processor that controls access to memory address ranges, on a native trusted execution environment, or on an NPU operating system. PL-4 indicates an operating system dependency requirement and a CPU and GPU hardware dependency requirement for the AI model. In examples, PL-4A is used when a user desires to implement hardware-based protection on a CPU and a GPU, whereas PL-4B is used when a user desires to implement hardened, custom-made hardware-based protection on a CPU and a GPU.

The usage of protections levels (e.g., protection levels 1-4) in protection level scheme 400 provides several benefits. For example, the usage of a protection level enables protection level properties to be aggregated into logical groups that can be agreed upon by model creators and model consumers (e.g., end users). These logical groups ensure that insecure combinations of protections are avoided, simply testing associated with applying protection levels to devices, and ensure the enforcement of license and compliance agreements. As another example, the usage of a protection level simplifies the protocols used for communication between devices (e.g., between cloud devices and client devices). For instance, a protection level may enumerate permitted or preferred communication protocols that can be used to enable devices to communicate with other (specified or unspecified) devices. As yet another example, the usage of a protection level simplifies queries for application and client device capabilities or configurations and ensures that devices enforce semantics associated with the queries. For instance, a protection level may specify the type of information for which one device may query another device, or the type of information one device may provide to another device. As still yet another example, the usage of a protection level enables a fixed set so enumerated values to be embedded within a license. For instance, instead of including multiple sets of protections levels in a license in order to ensure that all available protection levels are presented to a model consumer, only a subset of protection levels that are applicable to the selected AI model and/or client device (or application) or enumerated in the license.

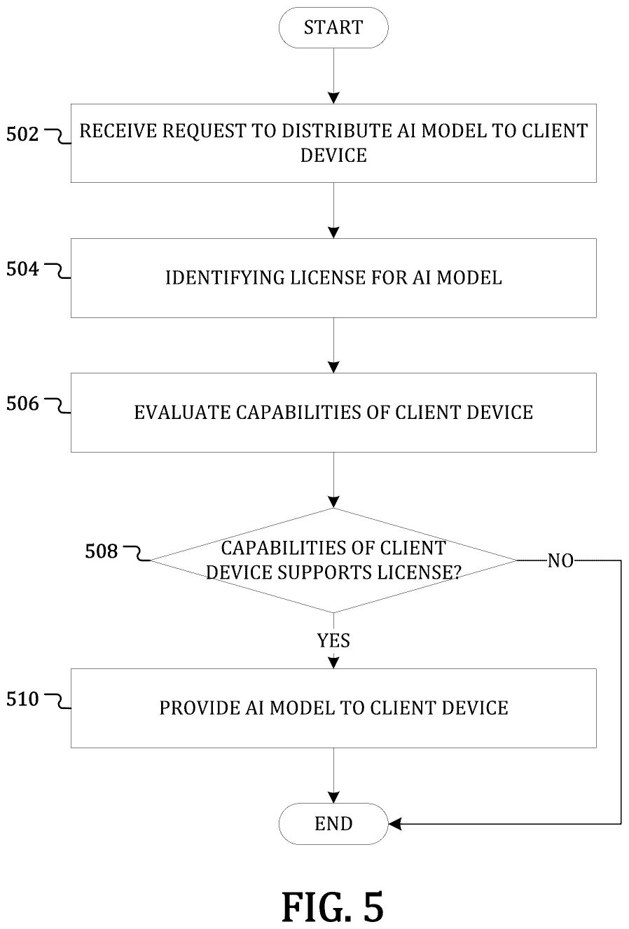

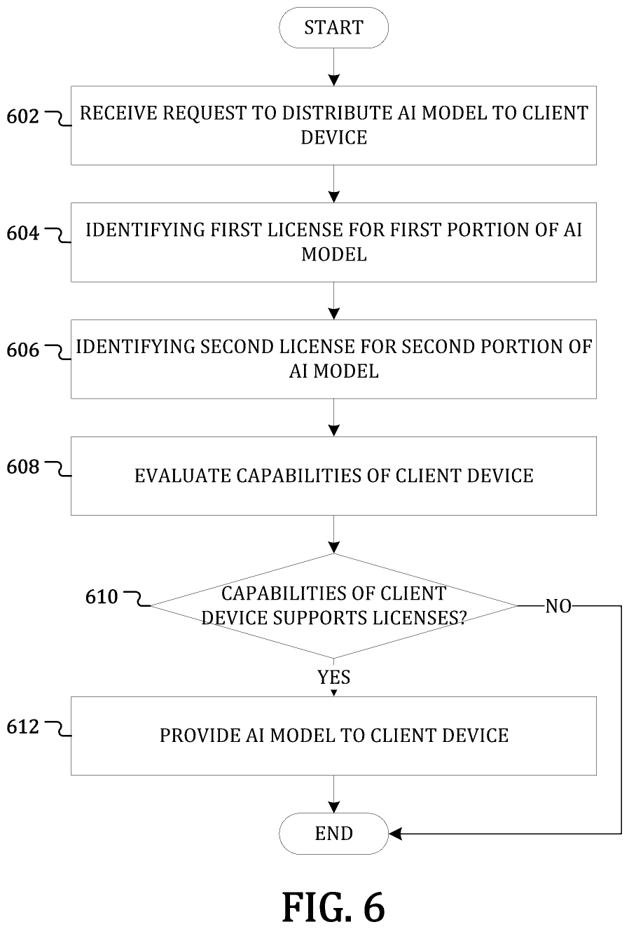

FIGS. 5 and 6 depict example methods for distributing an AI model to a client device in accordance with one or more licenses for the AI model. The methods in FIGS. 5 and 6 may be performed by one or more of the devices or components of the systems described above. In an example, the methods in FIGS. 5 and 6 are performed by client devices 102 and/or computing environment 202.

FIG. 5 depicts an example method 500 for distributing an AI model to a client device in accordance with a license for the AI model. Method 500 begins at operation 502, where a request to distribute an AI model to a client device is received. In examples, the request is provided by a client device (e.g., client devices 102) to a distribution service (e.g., distributed servers 110A and 110B) having access to one or more AI models. The request may identify a particular AI model, a particular AI model class (e.g., LLM, SLM, or RNN), a desired protection level (e.g., the protection levels (PL-1, PL-2, PL-3, and PL-4) described in FIG. 2), or a protection type (e.g., hardware-based protection or software-based protection). Alternatively, the request may indicate one or more tasks to be performed and the distribution service may select an AI model to provide to the client device based on the tasks to be performed. For example, the request may indicate an intent to perform the task of video and audio processing for multimedia content (e.g., video data, image data, audio data, and textual data). Based on the intended task, the distribution service may identify a particular AI model or a particular AI model class that is configured to be used to perform the intended task. For instance, the distribution service may identify one or more RRNs that are typically used to perform video and audio processing. In some examples, identifying the tasks that AI models are configured to perform comprises evaluating properties of the AI models (e.g., model name or identifier, model creator, model class, size, storage location, access control information, date and time information) or stored descriptions of the AI models. For instance, each AI model may be stored with an indication of an AI model class, a description of the AI model, and/or a description of the AI model class. The descriptions may indicate the types of tasks the AI model or AI model class is intended to or typically used to perform.

In at least one example, the distribution service may identify multiple candidate AI models in one or more AI model classes that are configured to be used to perform the intended task. The distribution service may select one of the candidate AI models randomly or based on various criteria for the AI models. Such criteria may include creation or modification date (e.g., preference may be given to recently created or modified AI models), stability (e.g., preference may be given to AI models that have historically proven to be stable or reliable), performance (e.g., preference may be given to more performant AI models), cost (e.g., preference may be given to less expensive AI models), popularity (e.g., preference may be given to AI models that have a high volume of recent selections), and semantic similarity (e.g., preference may be given to AI models that have properties or descriptions comprising that most closely match terms in an intended task). Alternatively, a user of the client device may select one of the candidate AI models. For instance, the distribution service may provide a notification of the candidate AI models (e.g., an email or a message via an interface used by the client device to submit the request for the AI model) to the client device. The notification may provide information related to each AI model, such as an identifier of the AI model, a description of the AI model, the cost of the AI model, the amount of time for authorized use of the AI model, a number of authorized uses of the AI model, requisite hardware the AI model must be able to access (on the client device), and the like. This information may be included within or representative of content in a license associated with AI model. The notification may also provide access to an interface that enables a user of the client device to select one of the candidate AI models. For instance, the notification may include a link (e.g., a hyperlink) to a graphical user interface or may embed a set of controls (e.g., checkboxes, radio buttons, dropdown lists, list boxes, text boxes) that enables a user of the client device to select one of the candidate AI models.

At operation 504, a license for the selected AI model is identified. In examples, in response to the selection of the AI model, the distribution service accesses a license server (or other licensing repository) storing one or more licenses for AI models (e.g., licensing server 112). Each of the licenses may include properties indicating the AI models to which the license is intended to be applied, one or more protection levels provided by the license (e.g., the protection levels (PL-1, PL-2, PL-3, and PL-4) described in FIG. 4), and/or client device requirements (e.g., hardware and/or software capabilities of a client device) that must be satisfied to enable the AI model to be distributed to the client device. The distribution service searches the license server for a license corresponding to the AI model. Searching for the license may comprise attempting to match properties of the AI model to properties of the license. For instance, a model identifier for the AI model may be compared to model identifiers that are stored as properties in the licenses. If a license matching the AI model is identified, the identified license is selected.

At operation 506, capabilities of the client device are evaluated. In examples, the distribution service or the license server attempts to identify the capabilities of the client device by querying the client device (e.g., sending commands to an API of the client device that is configured to identify device capabilities) or evaluating configuration files for the client device (e.g., installation logs or update logs). The identified capabilities of the client device are then compared to the client device requirements indicated by one or more protection levels of the license. In an alternative example, instead of the distribution service or the license server evaluating the capabilities of the client device, the client device requirements for one or more protection levels of the license are provided to the client device. A user of the client device then determines whether the client device satisfies the received client device requirements. The user may be required to certify that the client device satisfies the client device requirements as a requisite to receiving the model. In another alternative example, instead of the distribution service or the license server evaluating the capabilities of the client device, the distribution service or the license server may configure the client device or cause the client device to be configured. For instance, the client device may be required to install new components (e.g., software, firmware, or hardware) and/or to update existing components to cause the client device to be in compliance with the client device requirements for one or more protection levels of the license.

At decision operation 508, a determination is made regarding whether the capabilities of the client device support a protection level specified by the license for the model. If it is determined that the capabilities of the client device do not support a protection level specified by the license for the model, the model is not provided to the client device and method 500 ends. However, if it is determined that the capabilities of the client device support a protection level specified by the license for the AI model, method 500 proceeds to operation 510.

At operation 510, the AI model is provided to the client device. In some examples, based on the determined capabilities of the client device, the distribution service or the license server modifies the license for the AI model to indicate a selected protection level to be applied to the AI model. For instance, the license server may generate a new license that is specific to (e.g., is only usable by) the client device. The new license may include the same (or similar properties) of the selected license for the AI model. However, while the new license includes the selected protection level to be applied to the AI model, the non-selected protection levels are removed from the new license. In other examples, an indication of the selected protection level is applied to the AI model. For instance, the selected protection level or a protection type associated with a selected protection level may be embedded into the properties of the AI model. The AI model is then provided to the client device. In some examples, the license (or the new license) is also provided to the client device.

FIG. 6 illustrates an example method 600 for distributing an AI model to a client device in accordance with multiple licenses for the AI model. Method 600 begins at operation 602, where a request to distribute an AI model to a client device is received. In examples, the request is provided by a client device (e.g., client devices 102) to a distribution service (e.g., distributed servers 110) having access to one or more AI models. As discussed in operation 502 of FIG. 5, the request may identify a particular AI model, a particular AI model class, a desired protection level, a protection type, or one or more tasks to be performed. As also discussed in operation 502 of FIG. 5, in an example where multiple candidate AI models are identified, the distribution service or a user of the client device may select one of the candidate AI models.

At operation 604, a first license is identified for a first portion of the selected AI model. In examples, the AI model comprises at least a first portion corresponding to the data (e.g., weights) of the AI model and a second portion corresponding to the software code (e.g., operators, topology) of the AI model. In some examples, the portions of an AI model are predefined. For instance, the distribution service may be configured to identify each AI model as having a model data portion and a software code portions). In other examples, the portions of an AI model are customizable. For instance, as part of the request for the AI model, the user of the client device may indicate a desire to protect the model weights (e.g., a first portion), the model operators (e.g., a second portions), and the model topology (e.g., a third portion) of the AI model using separate licenses. The use of separate licenses to protect the three portions of the AI model may indicate that the user of the client device places a different level of importance on each of the three portions and/or the user of the client device expects a different likelihood of attack for each of the three portions. In another instance, as part of the request for the AI model, the user of the client device may indicate a desire to protect the AI model using a single license.

In response to the selection of the AI model, the distribution service accesses a license server (e.g., licensing server 112) storing one or more licenses that can be applied to the various portions of AI models. As discussed in operation 504 of FIG. 5, each of the licenses may include properties indicating the AI models (or the portions of the AI models) to which the license is intended to be applied, one or more protection levels provided by the license, and/or client device requirements that must be satisfied to enable the AI model to be distributed to the client device. The distribution service searches the license server for a license corresponding to the AI model. Searching for the license may comprise attempting to match properties of the AI model to properties of the license. For instance, a model identifier for the AI model may be compared to model identifiers that are stored as properties in the licenses. Upon determining one or more licenses that match the AI model, the distribution service evaluates the licenses to determine whether each license is applicable to the first portion of the AI model. For instance, each license may indicate the portions of the AI model that the license (or the individual protection levels specified by the license) is intended to protect. If a license matching the AI model and the first portion of the AI model is identified, the identified license is selected as the first license.

At operation 606, a second license is identified for the second portion of the selected AI model. As discussed in operation 604, the distribution service searches the license server for a license corresponding to the AI model. Upon determining one or more licenses that match the AI model, the distribution service evaluates the licenses to determine whether each license is applicable to the second portion of the AI model. For instance, if a license matching the AI model and the second portion of the AI model is identified, the identified license is selected as the second license. In some examples, the first and the second licenses are the same license. For instance, a license may indicate that one or more protections levels specified by the license are applicable to the first portion of the AI model and one or more other protections levels specified by the license are applicable to the second portion of the AI model.

At operation 608, capabilities of the client device are evaluated. In examples, as discussed in operation 506 of FIG. 5, the distribution service or the license server attempts to identify the capabilities of the client device by querying the client device or evaluating configuration files for the client device. The identified capabilities of the client device are then compared to the client device requirements indicated by one or more protection levels of the first and second licenses. In instances in which the client device requirements for the first and second licenses are different (e.g., the first license specifies required software capabilities of the AI model and the second license specifies required hardware capabilities of the AI model), the distribution service or the license server may apply rules for resolving the differences between the client device requirements. The rules may be evaluated in a predefined order (e.g., in descending order from the top of the rule set) or based on properties of the AI model and/or client device. For instance, some rules may only be applicable to certain AI models, AI model classes, client devices, or client device types, whereas are applicable to all or other types of AI models, AI model classes, client devices, or client device types. In some examples, the rules are evaluated such that all non-conflicting client device requirements must be satisfied by the client device. In other examples, the rules are evaluated such that only the most restrictive of the client device requirements must be satisfied by the client device.

In an alternative example, instead of the distribution service or the license server evaluating the capabilities of the client device, the client device requirements for one or more protection levels of the first and second licenses are provided to the client device. A user of the client device then determines whether the client device satisfies the received client device requirements. The user may be required to certify that the client device satisfies the client device requirements for the first and second licenses as a requisite to receiving the AI model. In another alternative example, instead of the distribution service or the license server evaluating the capabilities of the client device, the distribution service or the license server may configure the client device or cause the client device to be configured. For instance, the client device may be required to install new components (e.g., software, firmware, or hardware) and/or to update existing components to cause the client device to be in compliance with the client device requirements for one or more protection levels of the first and second licenses.

At decision operation 610, a determination is made regarding whether the capabilities of the client device support a first protection level specified by the first license for the AI model and/or a second protection level specified by the second license for the AI model. If it is determined that the capabilities of the client device do not support the first protection level and/or the second protection level for the AI model, the AI model is not provided to the client device and method 600 ends. However, if it is determined that the capabilities of the client device support the first protection level and/or the second protection level for the AI model, method 600 proceeds to operation 612.

At operation 612, the AI model is provided to the client device. In some examples, based on the determined capabilities of the client device, the first and/or second licenses may be modified to respectively indicate a selected protection level. For instance, the distribution service or the license server may modify the first license to indicate a selected protection level to be applied to the first portion of the AI model and/or modify the second license to indicate a selected protection level to be applied to the second portion of the AI model. In other examples, an indication of the selected protection level for each of the first and second licenses is applied to the AI model. For instance, each of the selected protection levels of the first and second licenses or a protection type associated with each of the selected protection levels may be embedded into the properties of the AI model.

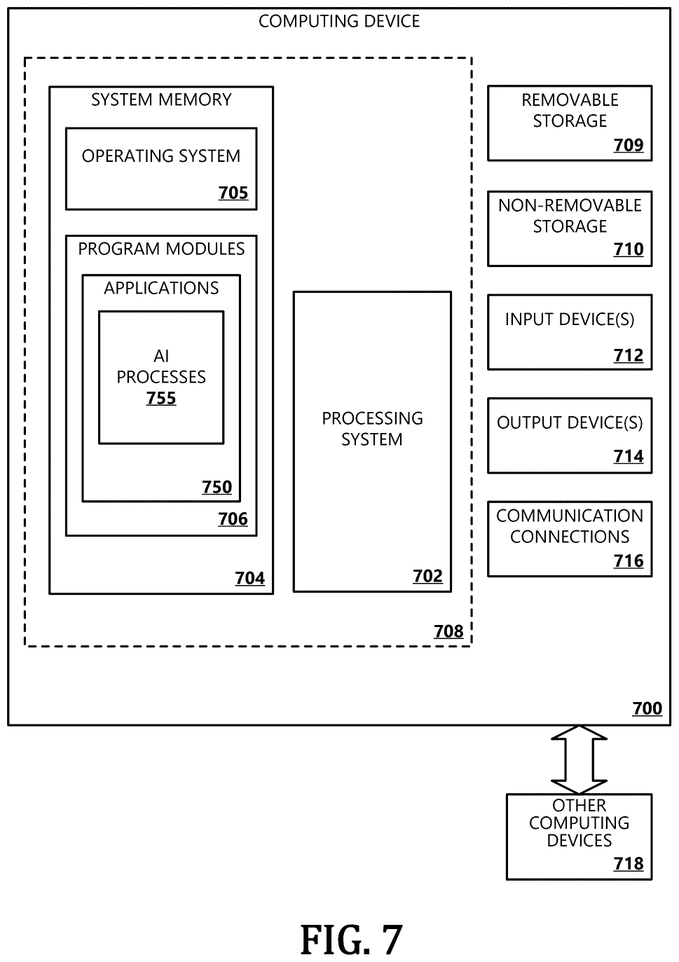

FIG. 7 and the associated description provide a discussion of a variety of operating environments in which examples of the invention may be practiced. However, the devices and systems illustrated and discussed with respect to FIG. 7 is for purposes of example and illustration and is not limiting of a vast number of computing device configurations that may be utilized for practicing aspects of the invention, described herein. FIG. 7 is a block diagram illustrating physical components (i.e., hardware) of a computing device 700 with which examples of the present disclosure may be practiced. The computing device components described below may be suitable for a client device running the web browser discussed above. In a basic configuration, the computing device 700 may include a processing system 702 including at least one processing unit and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 750. The software applications 750 may be any of the applications and/or processes discussed herein for handling the distribution and execution of the AI models and/or training sets discussed herein. Such applications and processes may be referred to collectively as AI processes 755.

The operating system 705, for example, may be suitable for controlling the operation of the computing device 700. Furthermore, aspects of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing system 702, the program modules 706 may perform processes including, but not limited to, one or more of the operations of the methods and/or data flows illustrated in the Figures. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 700 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As will be understood from the present disclosure, one example of the technology discussed herein relates to a system comprising: a processing system; and memory coupled to the processing system, the memory comprising computer executable instructions that, when executed, perform operations comprising: receiving a request to distribute an artificial intelligence (AI) model to a client device, the AI model comprising model weights and a model structure; identifying a license for the AI model, wherein the license specifies a first protection level for the model weights and a second protection level for the model structure; evaluating capabilities of the client device; determining the capabilities of the client device enable the client device to support the first protection level and the second protection level; and in response to determining the capabilities of the client device enable the client device to support the first protection level and the second protection level, providing the AI model to the client device.

In another example, the technology discussed herein relates to a method comprising: receiving a request to distribute an artificial intelligence (AI) model to a client device, the AI model comprising model weights and a model structure; identifying a first license for the AI model, wherein the first license specifies a first protection level for the model weights; identifying a second license for the AI model, wherein the second license specifies a second protection level for the model structure; evaluating capabilities of the client device; determining the capabilities of the client device enable the client device to support the first protection level and the second protection level; and in response to determining the capabilities of the client device enable the client device to support the first protection level and the second protection level, providing the AI model to the client device.

In another example, the technology discussed herein relates to a distribution device comprising: a processing system; and memory coupled to the processing system, the memory comprising computer executable instructions that, when executed, perform operations comprising: receiving a request to distribute an artificial intelligence (AI) model to a client device, the AI model comprising model weights and a model structure; identifying a license for the AI model, wherein the license specifies: a first protection level for the model weights; a second protection level for the model structure; and a third protection level for at least one of user input data provided to the AI model or user output data provided by a hardware device associated with the client device; determining capabilities of the client device enable the client device to support the first protection level, the second protection level, and the third protection level; and providing the AI model to the client device.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

What is claimed is:

1. A system comprising:
a processing system; and
memory comprising computer executable instructions that, when executed, perform operations comprising:
receiving a request to distribute an artificial intelligence (AI) model to a client device, the AI model comprising model weights and a model structure;
identifying a license for the AI model, wherein the license specifies a first protection level for the model weights and a second protection level for the model structure;
evaluating capabilities of the client device;
determining the capabilities of the client device enable the client device to support the first protection level and the second protection level; and
in response to determining the capabilities of the client device enable the client device to support the first protection level and the second protection level, providing the AI model to the client device.

2. The system of claim 1, wherein the request identifies at least one of:
a particular AI model;
a particular AI model class;
a desired protection level; or
a protection type.

3. The system of claim 1, wherein receiving the request comprises:
receiving, by a distribution service, the request from the client device, the distribution service being external to the client device and having access to a plurality of AI models.

4. The system of claim 3, wherein receiving the request further comprises:
identifying a task to be performed using the AI model; and
selecting, by the distribution service, the AI model based on the task, wherein the AI model is configured to be used to perform the task.

5. The system of claim 4, wherein selecting the AI model based on the task comprises at least one of:
evaluating properties of the AI model; or
evaluating a stored description of the AI model.

6. The system of claim 4, wherein selecting the AI model based on the task comprises:
selecting a multiple candidate AI models based on the task, the AI model being included in the multiple candidate AI models, wherein each of the multiple candidate AI models is configured to be used to perform the task;
providing the multiple candidate AI models for selection in an interface of the client device; and
receiving, via the interface, a user selection of the AI model from the multiple candidate AI models.

7. The system of claim 4, wherein selecting the AI model based on the task comprises:
selecting a multiple candidate AI models based on the task, the AI model being included in the multiple candidate AI models, wherein each of the multiple candidate AI models is configured to be used to perform the task;
evaluating the multiple candidate AI models based on at least one of:
creation date of the multiple candidate AI models;
performance of the multiple candidate AI models;
cost of the multiple candidate AI models cost; or
popularity of the multiple candidate AI models; and
selecting, by the distribution service, the AI model based on evaluating the multiple candidate AI models.

8. The system of claim 1, wherein identifying the license comprises:
identifying a licensing repository comprising licenses for multiple AI models, the license repository being external to the client device; and
evaluating the licenses for the multiple AI models by matching properties of the license to properties of the licenses for the multiple AI models; and
retrieving the license from the license repository based on evaluating the licenses for the multiple AI models.

9. The system of claim 1, wherein evaluating the capabilities of the client device comprises:
querying the client device for the capabilities of the client device;
receiving the capabilities of the client device from the client device; and
comparing the capabilities of the client device to client device requirements specified by the license.

10. The system of claim 1, wherein evaluating the capabilities of the client device comprises:
providing client device requirements for the AI model to the client device; and
receiving, from the client device, a determination of whether the client device satisfies the client device requirements.

11. The system of claim 1, wherein:
the first protection level specifies software-based protection and the second protection level specifies hardware-based protection; or
the first protection level specifies the hardware-based protection and the second protection level specifies the software-based protection.

12. The system of claim 1, wherein the license includes first properties for the first protection level and second properties for the second protection level.

13. The system of claim 12, wherein the first properties indicate at least one of:
threats managed by the first protection level;
a customer usage scenario for the first protection level; or
operating system platform requirements for implementing the first protection level.

14. A method comprising:
receiving a request to distribute an artificial intelligence (AI) model to a client device, the AI model comprising model weights and a model structure;
identifying a first license for the AI model, wherein the first license specifies a first protection level for the model weights;
identifying a second license for the AI model, wherein the second license specifies a second protection level for the model structure;
evaluating capabilities of the client device;
determining the capabilities of the client device enable the client device to support the first protection level and the second protection level; and
in response to determining the capabilities of the client device enable the client device to support the first protection level and the second protection level, providing the AI model to the client device.

15. The method of claim 14, the method further comprising:
identifying a third license for the AI model, wherein the third license specifies a third protection level for user input data provided to the AI model.

16. The method of claim 14, the method further comprising:
providing the first license and the second license the client device.

17. The method of claim 14, wherein first client device requirements for implementing the first license on the client device are different from second client device requirements for implementing the second license on the client device.

18. The method of claim 17, wherein resolution rules stored by the client device are used to resolve differences between the first client device requirements and the second client device requirements.

19. The method of claim 14, wherein providing the AI model to the client device comprises applying an indication of the first protection level and the second protection level to the AI model.

20. A distribution device comprising:
a processing system; and
memory comprising computer executable instructions that, when executed, perform operations comprising:
receiving a request to distribute an artificial intelligence (AI) model to a client device, the AI model comprising model weights and a model structure;
identifying a license for the AI model, wherein the license specifies:
a first protection level for the model weights;
a second protection level for the model structure; and
a third protection level for at least one of user input data provided to the AI model or user output data provided by a hardware device associated with the client device;
determining capabilities of the client device enable the client device to support the first protection level, the second protection level, and the third protection level; and
providing the AI model to the client device.
